(19) United States
(12) Patent Application Publication
(10) Pub. No.: US 2016/0005114 A1
(43) Pub. Date: Jan. 7, 2016

(54) SEAMLESS PROGRESSION OF CREDIT RELATED PROCESSES ON A MOBILE DEVICE

(71) Applicant: Comenity LLC, Columbus, OH (US)

(72) Inventors: James Eversole DONOVAN, Upper Arlington, OH (US); David NACK, Bexley, OH (US)

(73) Assignee: COMENITY LLC, Columbus, OH (US)

(21) Appl. No.: 14/738,577

(22) Filed: Jun. 12, 2015

Related U.S. Application Data
(60) Provisional application No. 62/020,324, filed on Jul. 2, 2014.

(51) Int. Cl. G06Q 40/02; G06Q 20/32

(52) U.S. Cl. CPC G06Q 40/025; G06Q 20/3221

(57) ABSTRACT

In a computer-implemented method for seamless progression of credit related processes on a mobile device, a user is prompted for credit application information via the mobile device for credit card application processing. Credit application information is received at the mobile device. Approval of a credit card account based on the application information is presented at the mobile device. Use of a digital credit card for repeat purchases is enabled via the mobile device. The digital credit card is associated with the credit card account. There is a seamless progression of credit related processes on the mobile device.

### CROSS-REFERENCE TO RELATED APPLICATIONS

This application claims priority to U.S. Provisional Patent Application 62/020,324, filed on Jul. 2, 2014, entitled “SEAMLESS PROGRESSION OF CREDIT RELATED PROCESSES ON A MOBILE DEVICE” by James Eversole Donovan et al. having Attorney Docket No. ADS-079.PRO, and assigned to the assignee of the present application, hereby incorporated by reference in its entirety.

### BACKGROUND

The process of applying for a credit card, registering for the credit management account, and subsequently using the credit card for purchases, once approved, can be cumbersome and elongated. For example, it may take days or weeks for a credit card to be physically made and subsequently delivered to the cardholder.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 is a block diagram that illustrates an embodiment of a system for seamless progression of credit related processes on a mobile device.

FIG. 2 depicts a flow diagram for a method for seamless progression of credit related processes on a mobile device, according to various embodiments.

FIG. 3 depicts a flow diagram for a method for registering for a credit card management account, according to various embodiments.

FIGS. 4A-C depicts screenshots of a process for credit card account management registration.

### DESCRIPTION OF EMBODIMENTS

Reference will now be made in detail to various embodiments, examples of which are illustrated in the accompanying drawings. While various embodiments are discussed herein, it will be understood that they are not intended to be limiting. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding. However, embodiments may be practiced without one or more of these specific details. In other instances, well known methods, procedures, components, and circuits have not been described in detail as not to unnecessarily obscure aspects of the described embodiments.

### Example Embodiments of a Retail System

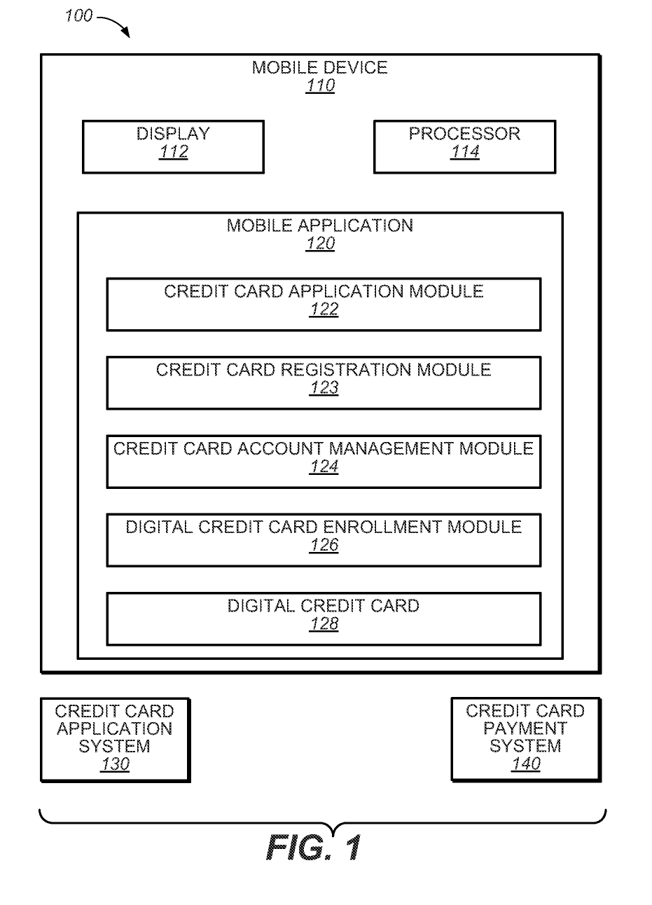

FIG. 1 depicts a system 100 for seamless progression of credit related processes on a mobile device. That is, system 100 enables a seamless progression (or a substantially uninterrupted) of processes related to application for a credit card, registration of a credit card, and use of a credit card through a mobile application executing on a mobile device.

Additionally, system 100 provides for mobile experiences that work together, seamlessly, in order to allow consumers to go from being a non-credit customer to being a customer that can use a credit card on demand with a mobile device, within a matter of minutes.

System 100 includes mobile device 110 that includes various components such as, but not limited to, display 112, processor 114, and various mobile applications (e.g., mobile application 120) that are downloaded and executable on mobile device 110.

Mobile device 110 can be any mobile computing device such as a mobile phone, smart phone, PDA, computing tablet (e.g., iPad), etc.

Mobile application 120 is an application that is downloaded on mobile device 110 and is executed by processor 114.

Mobile application 120 is configured to provide a seamless experience, to the user, during various processes associated with applying for a credit card through repeated use of a virtual credit card. For example, various credit card related processes are each performed quickly and efficiently such that user is able to apply for a credit card, register for a credit card management account associated with that credit card, and subsequently use a virtual credit card for repeated purchases within minutes. Each of the processes are performed and executed by of way of mobile application 120.

The term “seamless,” as described generally means credit card associated processes are visualized with a common look and feel via mobile application 120, and the processes are performed sequentially without undue delay or interruption such that a user is able to apply for a credit card, register for a credit card management account associated with that credit card and make repeated purchases with a virtualized credit card within minutes.

The various processes seamlessly implemented by mobile application may be, but are not limited to the following: (1) applying for a credit card, (2) creating a or registering for credit card management account, (3) enrolling for a digital (or virtual) credit card, and (4) enabling a cardholder to use the digital credit card for repeat use.

In various embodiments, the credit related processes described herein, that are seamlessly implemented, may be completed sequentially.

In one embodiment, mobile application 120 may be provided by a retailer, such as any retailer that provides goods (e.g., apparel, accessories) for sale via online and/or via brick and mortar stores.

In another embodiment, mobile application 120 is provided by a credit card issuer that issues and processes credit cards for various credit card programs.

Mobile application 120 includes various modules for the seamless progression and processing of the credit related process steps. For instance, mobile application 120 includes credit card application module 122, credit card registration module 123, credit card account management module 124, digital credit card management module 126, and digital credit card 128.

Credit card application module 122 is configured to facilitate in processing a credit card application via mobile application 120 executing on mobile device 110.

It is noted that a user can apply for a credit card at any location where the mobile device is able to receive the requisite cell phone service or internet service. For example, the user may apply for a credit card when the user is not in a brick and mortar store of a given retailer at which the credit card may be used.

Module 122 can prompt a user for credit application information (e.g., name, address, social security number, zip code, date of birth etc.). In response, the user provides the credit application information via display 112. For example, the user types in the information on display 112 which is a touch screen display.

The information is transmitted to credit card application system 130 for processing. System 130 processes the provided credit application information to determine if the user is qualified for a credit account.

System 130 can include a credit bureau or consumer reporting agency (e.g., Experian, Equifax, etc.) that provides a credit score or other credit determinative analysis based on the provided credit application information. Additionally, system 130 is managed/controlled by the credit card issuer.

If the credit card application is approved, the approval is transmitted to credit card application module 122 from credit card application system 130. The approval is then presented to the user via display 122.

Once approved for a credit card, there is a seamless transition from applying for a credit card to creating/registering a credit card management account. For example, in response to being approved for a credit card, the user may then be prompted to create a credit card account to manage the credit card account, such as bill pay, etc. Credit card registration module 123, in one embodiment, implements the process for registration of a credit card management account.

Credit card account management module 124, in one embodiment, implements the process for creating the credit card account. For example, when a user selects to create a credit card account, the use may then be prompted to enter a username, a password. The user may also be prompted to agree to various terms and conditions regarding the account. The user may enter the information and accept the terms/conditions via display 112.

It is noted that the user may register for a credit card account without requiring a credit card number. For instance, the user recently was approved for a credit card, however, the credit card was not manufactured at the time for registering for the credit card account. As such, the credit card number was not available to the user and therefore not required when registering for the credit card account.

Other information may be accessed and provided for registering, such as, but not limited to social security number or other personalized data (e.g., name, address, zip code, date of birth, etc.).

The registration for the credit cart management account, in one embodiment, can be implemented via mobile device 110. For example, mobile application 120 prompts a user for the registration information at the mobile device and the user provides the registration at the mobile device. Once registered, mobile application 120 enables the user to manage the credit cart management account through mobile device 110.

The registration for the credit cart management account, in another embodiment, can be web based. For example, a user, who is visiting a website that enables registration, may register for the credit cart management account by providing registration information through the website. Once registered, the user may manage the credit card management account through the website.

In one embodiment, registration of the credit card management account is based on the provided registration information. In particular, the registration information is cross-referenced with the previously provided credit card application information. If the registration information for the credit card management account corresponds with the credit card application information then the user is registered for the credit card management account.

Once registered for a credit card account to manage the credit card, there is a seamless transition to enrolling for a digital credit card, such as digital credit card 128. For example, in response to registering for a credit card management account, the user may then be prompted to enroll for a digital credit card. The digital credit card is a mobile payment method.

A digital or electronic credit card is an electronic or digital version of a physical credit card.

The credit card account enables a user to make payments with the credit card payment system 140 which manages and controls the credit card account. For example, credit card payment system 140 is managed and controlled by the card issuer, such as a private label card issuer.

Digital credit card enrollment module 126, in one embodiment, prompts a user to enroll for a digital credit card. For example, a user is prompted to accept or decline enrollment for a digital credit card. The user may select or decline via selection on display 112. The acceptance may include acceptance of terms and conditions for using a digital credit card.

Upon acceptance, there is a seamless transition from enrolling for the digital credit card to having immediate access to the digital credit card such that the user is able to use the digital credit card for repeated use. For example, digital credit card 128 is immediately provided to the user such that the user may use the digital credit card for repeated purchases.

The digital credit card, in one embodiment, is displayed via display 112. The digital credit card may display the credit card number.

Digital credit card 128 can be any digital credit card that is able to be displayed on display 112 and utilized for purchases. In one embodiment, digital credit card 128 is implemented via application 120. When a user of device 110 selects application 120 to be utilized, processor 114 executes application 120 such that digital credit card 128 is eventually displayed on display 112.

### Example Methods of Operation

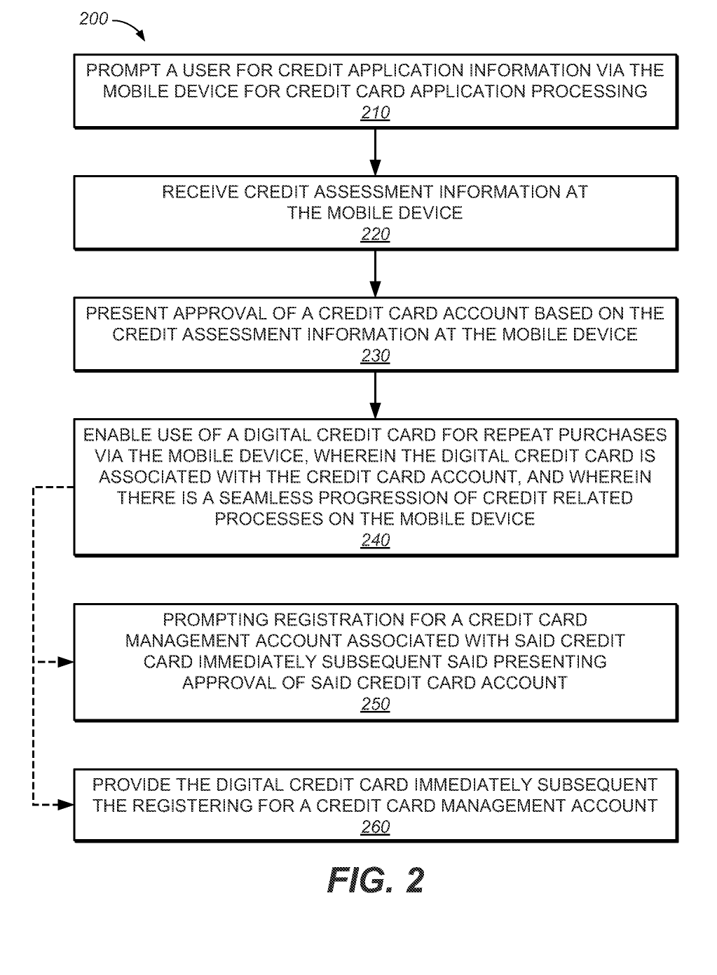

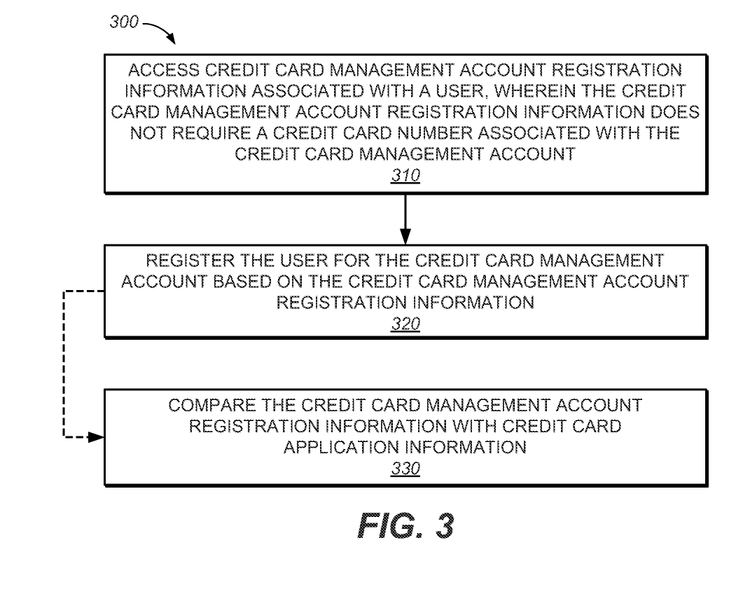

The following discussion sets forth in detail the operation of some example methods of operation of embodiments. With reference to FIGS. 2 and 3, flow diagrams 200-300 illustrate example procedures used by various embodiments. Flow diagrams 200-300 include some procedures that, in various embodiments, are carried out by a processor under the control of computer-readable and computer-executable instructions. In this fashion, procedures described herein and in conjunction with diagrams 200-300 are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments and/or cloud environments. The computer-readable and computer-executable instructions, which reside on tangible computer readable storage media, are used to control or operate in conjunction with, for example, one or some combination of processors of the computer environments and/or cloud environment. It is appreciated that the processor(s) may be physical or virtual or some combination (it should also be appreciated that a virtual processor is implemented on physical hardware). Although specific procedures are disclosed in diagrams 200-300, such procedures are examples. That is, embodiments are well suited to performing various other procedures or variations of the procedures recited in diagrams 200-300. Likewise, in some embodiments, the procedures in diagrams 200-300 may be performed in an order different than presented and/or not all of the procedures described in one or more of these flow diagrams may be performed. It is further appreciated that procedures described in diagrams 200-300 may be implemented in hardware, or a combination of hardware with firmware and/or software.

FIG. 2 depicts a process flow diagram 200 for a method for seamless progression of credit related processes on a mobile device, according to various embodiments.

At 210, a user is prompted for credit application information via the mobile device for credit card application processing. For example, a user is interested in applying for a credit card. The user may provide user input to initiate the process for applying for a credit card (e.g., scan a barcode, visit a website, etc.). Accordingly, the user is prompted to provide credit application information.

At 220, credit application information is received at the mobile device. For example, the user enters credit application information at the mobile device via display 112. The information is then transmitted to credit card application system 130 for processing.

At 230, approval of a credit card account based on the credit application information is presented at the mobile device. For example, if a user is approved for a credit card account by credit card application system 130, system 130 communicates to the mobile device 110 that the user has been accepted. In such an example, the approval is displayed on display 112.

At 240, use of a digital credit card is enabled for repeat purchases via the mobile device, wherein the digital credit card is associated with the credit card account, and wherein there is a seamless progression of credit related processes on the mobile device. For example, a user registers to use digital credit card 128 after being approved for a credit card account. Digital credit card 120 is able to be displayed on display 112 such that a user is able to purchase items/goods with the digital credit card.

At 250, registration for a credit card management account associated with the credit card is prompted immediately subsequent to presenting approval of the credit card account. For example, immediately following presenting approval of the credit card account, the registration for a credit card management account associated with the credit card is seamlessly prompted.

At 260, the ability to enroll for a digital credit card is provided immediately subsequent to registering for a credit card management account. For example, in response to a user registering to use a digital credit card, digital credit card 128 is provided to the user such that the user is immediately able to purchase items with provided digital credit card via mobile device 110.

It is noted that any of the procedures, stated above, regarding flow diagram 200 may be implemented in hardware, or a combination of hardware with firmware and/or software. For example, any of the procedures are implemented by a processor(s) of a cloud environment and/or a computing environment.

FIG. 3 depicts a process flow diagram 300 for registering for a credit card management account, according to various embodiments.

At 310, credit card management account registration information associated with a user is accessed, wherein the credit card management account registration information does not require a credit card number associated with the credit card management account. For example, a user is prompted to register for a credit card management account. Accordingly, the user provides credit card management account registration information for registering. The registration information does not include a credit card number associated with the credit card management account.

At 320, the user is registered for the credit card management account based on the credit card management account registration information. For example, the user is registered for the credit card management account without providing a credit card number.

At 330, the credit card management account registration information is compared to credit card application information. For example, the user is registered if the credit card management account registration information matches or corresponds to the previously provided credit card application information.

It is noted that any of the procedures, stated above, regarding flow diagram 300 may be implemented in hardware, or a combination of hardware with firmware and/or software. For example, any of the procedures are implemented by a processor(s) of a cloud environment and/or a computing environment.

### Examples of Credit Card Management Account Registration

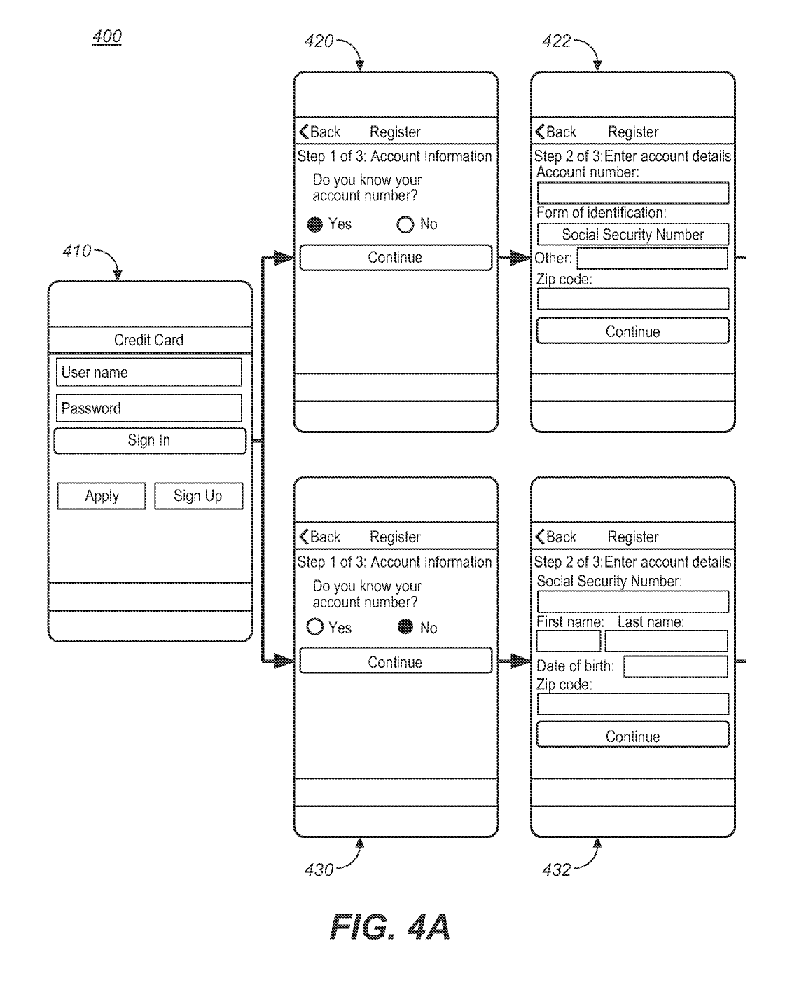

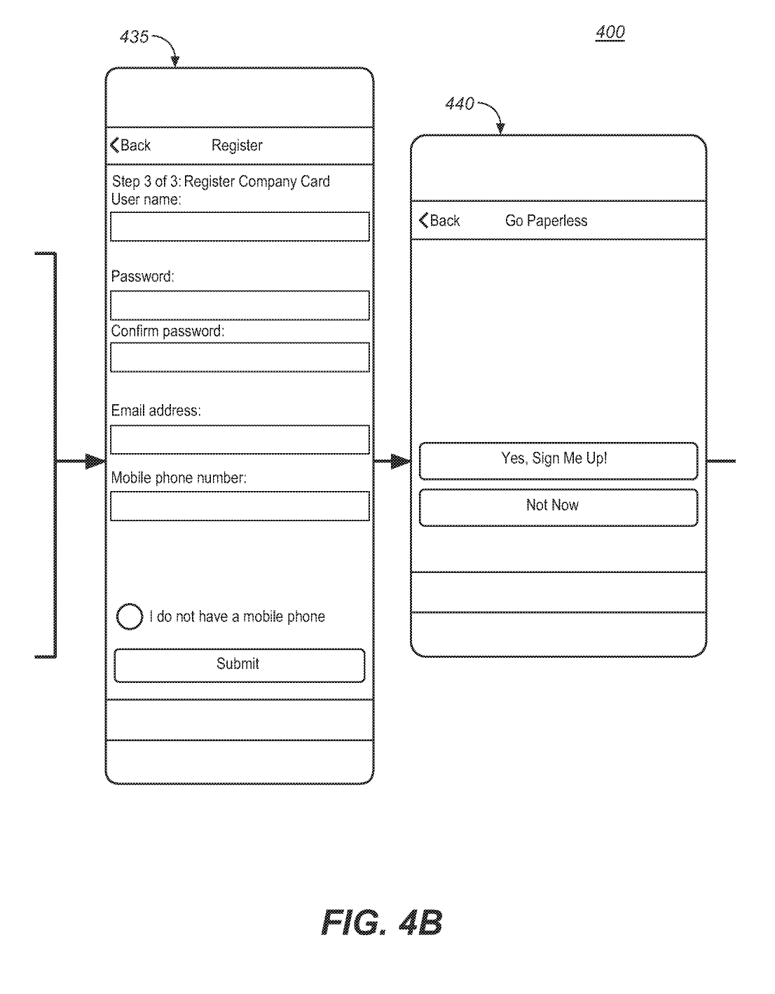

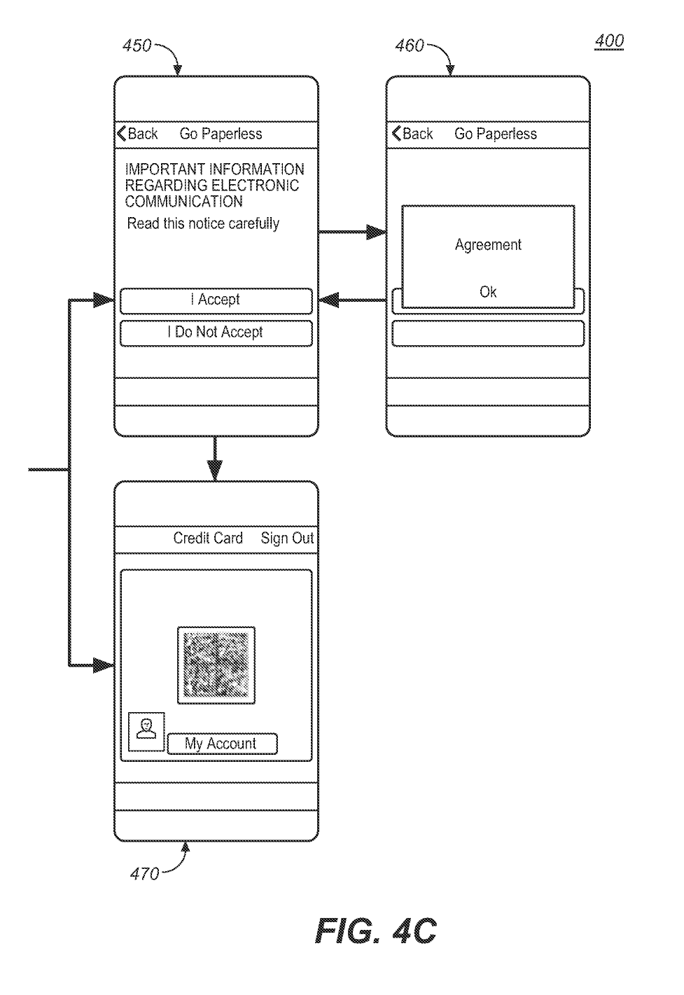

FIGS. 4A-C depicts a progression of screenshots of a process 400 for credit card account management registration via a mobile application (e.g., mobile application 120).

At 410, a user is prompted to apply to register for a credit card account management (or log in if already registered).

At 420 (and at 430), a user is queried if they can register via their account number (e.g., credit card number).

If the user selects ‘yes’ at 420, then at 422 the user is prompted for the account number and other information (e.g., social security number, zip code, etc.) to facilitate in verifying the user.

If the user selects ‘no’ at 430, then at 432 the user is prompted for credit card management account registration information (e.g., social security number, zip code, etc.) to facilitate in verifying the user.

Next, at 435, a user is prompted to select a username and password. Also the user is prompted for other information (e.g., email address, phone number) that is associated with the account.

Once the registrations information is submitted, the information to verify that the user registering for the credit card management account is the same person who is registered for the credit card associated with the account.

In one embodiment, at 440, the user is prompted for various options associated with the account, such as, a paperless account.

At 450, terms and conditions are displayed to the user and the user is prompted to accept or not accept the terms and conditions.

At 460, a message is displayed that an email is sent to the user containing the agreement regarding the credit card management account.

At 470, the digital credit card associated with the credit card management account is displayed. It should be appreciated that the digital credit card may be displayed at any time once the user is registered for using the digital credit card.

Example embodiments of the subject matter are thus described. Although various embodiments of the have been described in a language specific to features and/or methodological acts, it is to be understood that the appended claims are not necessarily limited to the specific features or acts described above. Rather, the specific features and acts described above are disclosed as example forms of implementing the claims and their equivalents. Moreover, examples and embodiments described herein may be implemented alone or in various combinations with one another.

1. A computer-implemented method for seamless progression of credit related processes on a mobile device, comprising:
prompting a user for credit application information via said mobile device for credit card application processing;
receiving credit application information at said mobile device;
presenting approval of a credit card account based on said credit application information at said mobile device; and
enabling use of a digital credit card for repeat purchases via said mobile device, wherein said digital credit card is associated with said credit card account, and wherein there is a seamless progression of credit related processes on said mobile device.

2. The computer-implemented method of claim 1, further comprising:
prompting registration for a credit card management account associated with said credit card immediately subsequent said presenting approval of said credit card account.

3. The computer-implemented method of claim 1, further comprising:
registering for a credit card management account associated with said credit card without requiring a credit card number associated with said credit card management account.

4. The computer-implemented method of claim 1, wherein registration information for registering for said credit card management account is cross-referenced with said credit application information.

5. The computer-implemented method of claim 1, further comprising:
providing said digital credit card immediately subsequent approval of a registration for a credit card management account.

6. The computer-implemented method of claim 1, wherein said credit card information is selected from a group consisting of name, social security number, zip code and date of birth.

7. A non-transitory computer-readable storage medium having instructions embodied therein that when executed cause a computer system to perform a method for seamless progression of credit related processes on a mobile device, said method comprising:
prompting a user for credit application information via said mobile device for credit card application processing;
receiving credit application information at said mobile device;
presenting approval of a credit card account based on said credit application information at said mobile device; and
enabling use of a digital credit card for repeat purchases via said mobile device, wherein said digital credit card is associated with said credit card account, and wherein there is a seamless progression of credit related processes on said mobile device.

8. The non-transitory computer-readable storage medium of claim 7, further comprising:
prompting registration for a credit card management account associated with said credit card immediately subsequent said presenting approval of said credit card account.

9. The non-transitory computer-readable storage medium of claim 7, further comprising:
registering for a credit card management account associated with said credit card without requiring a credit card number associated with said credit card management account.

10. The non-transitory computer-readable storage medium of claim 7, wherein registration information for registering for said credit card management account is cross-referenced with said credit application information.

11. The non-transitory computer-readable storage medium of claim 7, further comprising:
providing said digital credit card immediately subsequent approval of a registration for a credit card management account.

12. The non-transitory computer-readable storage medium of claim 7, wherein said credit card information is selected from a group consisting of name, social security number, zip code and date of birth.

13. A computer-implemented method for registering for a credit card management account, comprising:
accessing credit card management account registration information associated with a user, wherein said credit card management account registration information does not require a credit card number associated with said credit card management account; and
registering said user for said credit card management account based on said credit card management account registration information.

14. The computer-implemented method of claim 13, wherein said credit card management account registration information is accessed via a mobile device.

15. The computer-implemented method of claim 14, further comprising:
comparing said credit card management account registration information with credit card application information.
